(19) United States
(12) Patent Application Publication
(10) Pub. No.: US 2022/0234358 A1
(43) Pub. Date: Jul. 28, 2022

(54) INTELLIGENT IDENTIFICATION AND REVIVING OF MISSING JETS BASED ON CUSTOMER USAGE

(71) Applicant: Xerox Corporation, Norwalk, CT (US)

(72) Inventors: Christine Ann Steurrys, Williamson, NY (US); Robert E. Rosdahl, JR., Ontario, NY (US); Richard P. Ficarra, Williamson, NY (US); Robert R. Reed, West Henrietta, NY (US)

(73) Assignee: Xerox Corporation, Norwalk, CT (US)

(21) Appl. No.: 17/161,205

(22) Filed: Jan. 28, 2021

(51) Int. Cl. B41J 2/165; G06N 20/00

(52) U.S. Cl. CPC B41J 2/16517; B41J 2002/16573; G06N 20/00

(57) ABSTRACT

A system includes a processor that executes computer executable components stored in a memory. The system includes a first component to receive data generated by at least one sensor. The system further includes a second component to generate an array that determines between activating one of a purge routine and a diagnostic routine on a printhead based on the array. The array is a function of the data. The system further includes a control component operable to selectively activate the purge routine on the printhead based on the determination.

### BACKGROUND

The present exemplary embodiments relate to a system for maintaining printheads and, more particularly, for maintaining and restoring inoperable nozzles on a printhead faceplate. It will be described with reference to aqueous ink printing technology in industrial and home printers. However, it is to be appreciated that the present exemplary embodiments are also amendable to other like printing and imaging applications.

Inkjet imaging devices eject liquid ink from printheads to form images on a print media moving through the device. The printheads each include a plurality of inkjets (hereinafter synonymously referred to as “nozzles”) arranged in some type of array. To form an image, printheads are selectively activated to expand into an ink chamber and eject ink droplets onto the media. The ink, dropped from the nozzles, create the pixels that form the text and images.

One problem that inkjet devices suffer from is a tendency of the nozzles to become blocked or clogged over time. This may occur for a variety of reasons, but it is often associated with contamination and/or long latency periods. When a blockage occurs, the effected nozzles are unable to eject the ink droplets. Commonly observed artifacts of inoperable (or “missing”) nozzles may appear as missing dots or a striation—i.e., streaks of lighter color or white that appear across a printed area—within a printed image.

One way to mitigate the effect of a fully or partially nonfunctional nozzle is to employ redundant (“substitute”) nozzles to compensate for the missing ones. Known algorithms will hide missing nozzles in a printed image by printing pixels using neighboring jets. The statistical usage of some problematic nozzles may not necessitate their being fixed, particularly in view of substitution opportunities. A missing nozzle detection is not by itself a justification for attempting corrective action. However, when the images being printed require more printable jets than ones that are available in an area, it can noticeably deteriorate the quality of the printed image.

Currently, the main approach for fixing inoperable nozzles is to employ frequent purge cycles to revive or restore missing nozzles to an operational state. In a purge cycle, the printhead is purged with a volume of fresh ink prior to the printing operation. This approach is employed as a preventative and reactionary measure. While purging can effectively counteract blockages that are caused by an increase in ink viscosity and/or a long latency period, it is ineffective when the missing jets are caused by something else. The purge becomes a trial-and-error approach when the reason for the nozzle inoperability is less certain. Nozzle inoperability may result from a variety of other causes including an intrusion of air bubbles; low humidity or a relatively dry ambient condition; adhesion of dust or paper dust, a malfunction of the ink delivery or purge systems, and the like. What causes the missing nozzles can be difficult to diagnose, so an unnecessary purge cycle wastes time and money. Each purge cycle requires fresh ink that goes to waste, thus raising environmental concerns too. Additionally, more than one purge of a printhead may be required to restore a few missing nozzles among thousands of operational ones. Thus, purging is not a preferred operation for short latency periods and uncertain diagnoses.

Historically, an operator had initiated and governed the purging operation. As imaging devices evolved to include a higher nozzle density, they began to incorporate diagnostic tools that automatically initiate corrective actions to improve the image quality. These capabilities brought about a new problem: they employ costly or poorly timed corrective action when more appropriate solutions are available.

An improved system is desired in which unnecessary purge cycles are reduced and/or eliminated while maintaining inkjet performance. A system is desired which determines when and under what circumstances a recovery process is utilized. Disclosed herein is a system that employs machine learning and artificial intelligence (AI) to guide the purge and corrective strategies for missing nozzles.

### BRIEF DESCRIPTION

The present embodiments are directed to a system that observes printhead nozzles over time to model behavior of the printheads in an inkjet imaging device. This enables the system to predict the output (more specifically, the quality of the print jobs) to be generated by the device. This prediction further enables the system to determine how certain corrective or mitigating actions would improve the quality of the future output, and to automatically initiate an action on the device, when appropriate.

Disclosed herein is one embodiment of a system operative on a printhead. The system includes a processor that executes the following computer executable components stored in a memory. The system includes a first component to receive data generated by at least one sensor. The system further includes a second component to generate an array that determines between activating one of a purge routine and a diagnostic routine on a printhead based on the array. The array is a function of the data. The system further includes a control component operable to selectively activate the purge routine on the printhead based on the determination.

Also disclosed herein is another embodiment of a system operative on a printhead. The system includes an ink-jet recording device having a printhead that ejects ink droplets from a plurality of nozzles. The system includes a first sensor to detect data relating to the nozzles on the printhead. The system further includes a processor to execute computer executable components stored in a memory having a machine learning component. The machine learning component employs artificial intelligence (AI) to learn the data generated by the sensor for determining between selectively activating one of a purge routine and not activating the purge routine.

Further disclosed herein in another embodiment of a system for use with a printhead. The system includes a non-transitory storage device having stored thereon instructions for acquiring data from a drop sensor monitoring nozzles on a printhead; by using the data, generating a map representing the nozzles on the printhead; employing artificial intelligence to forecast potential imperfections in images to be rendered by the printhead; and selectively performing maintenance on the printhead based on a forecasted imperfection. The system further includes at least one hardware processor that is part of a computing device and configured to execute the instructions. The system also includes an air source in communication with the computing device for purging the printhead during the maintenance.

### BRIEF DESCRIPTION OF THE DRAWINGS

FIG. 1 is a schematic illustration of the disclosed system for maintaining printhead performance.

FIGS. 2A-2D is a flow chart showing a workflow for maintaining a printhead according to one aspect of the exemplary embodiment.

FIG. 3 is an example array generated by the system of FIG. 1.

FIG. 4 is example map showing missing nozzles over time.

### DETAILED DESCRIPTION

Disclosed in various embodiments herein is a system and method for maintaining printhead performance in inkjet imaging devices. The system observes nozzle behavior over time to predict the output produced by a printhead on which certain measures are or could be taken. The system, and method, create an intelligent balance between corrective actions and alternative mitigating efforts. Corrective actions, such as purges or replacements, are avoided when they may incur time and waste while other mitigating efforts, such as nozzle substitution, are employed when they boost efficiency and reduce waste.

As used herein, a “nozzle” is an ink expulsion device that propels ink onto paper or other print media through a small-diameter orifice.

As used herein, an “inkjet imaging device” is an aqueous ink printer, solid ink printer, a copier, laser printer, bookmaking machine, facsimile machine, or a multifunction machine (which includes one or more functions such as scanning, printing, archiving, emailing, and faxing) and the like (hereafter referred to as a “printer”) that use printheads with a series of nozzles to create the pixels that make up text and images. The inkjet imaging device can be industrial, commercial, office or home printers.

As used hereafter, an “array” is data in the form of a multi-(such as two)-dimensional matrix. Further, the array is a map or matrix representative of the placement of nozzles on the printhead. The number of nozzles included on a typical printhead can be in the thousands and, more typically, around 5000. The array is a matrix or map that shows the operational status of each nozzle on the printhead.

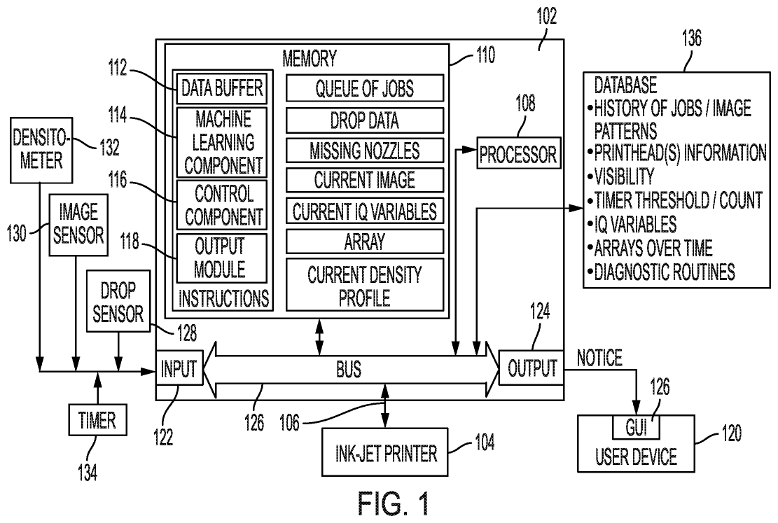

FIG. 1 is a schematic illustration of a system 100 for maintaining printer performance, according to one aspect of the exemplary embodiment. The system 100 may be hosted by a computing device 102 such as a digital front end (“DFE”) or controller, and an inkjet imaging device or printer 104, which are linked together by communication links 106, referred to herein as a network. These components are described in greater detail below. While computing device 102 and printer 104 are illustrated by way of example, the system 100 may be hosted by fewer or more linked computing devices. Each computing device may include, for example, a server computer, desktop, laptop, or tablet computer, smartphone or any other computing device capable of implementing the method described herein. Alternatively, the computing device 102 can be incorporated in the printer 104.

The computing device 102 illustrated in FIG. 1 includes a processor 108, which controls the overall operation by execution of processing instructions, which are stored in memory 110 connected to the processor 108. The processor 108 is a hardware device for executing software instructions. The processor 108 can be a custom made or commercially available processor, a central processing unit (CPU), an auxiliary processor among several processors associated with the server computer, a semiconductor based microprocessor (in the form of a microchip or chip set), or generally any device for executing software instructions.

The operation disclosed herein is performed by the processor 108 according to the instructions stored in the memory 110. In particular, the memory 110 stores a data buffer 112; a machine learning component 114; a control component 116; and an output module 118. These modules 112-118 will be later described with reference to the exemplary method. In general, the data buffer 112 acquires sensor data and preprocessed image data and applies the data to the machine learning component 114. The machine learning component 114 employs machine learning and artificial intelligence (AI) to forecast potential defects in images to be rendered by the printheads. The control component 116 is operable to selectively activate a purge routine or other corrective action on the printhead or other parts of the inkjet imaging device. The output module 118 transmits a notice or request for service to a user device 120 in communication with the system. These notices can be communicated as emails, text messages, pop-up messages or the like. In certain embodiments, they may be transmitted to only users logged into the system.

The computing device 102 includes one or more communication interfaces (I/O), such as network interfaces 122, 124 for communicating with external devices, such as the printer 104 and/or user device 120. The various hardware components 108, 110 (including random access memory “RAM”) of the computing device 102 may all be connected by a bus 126.

With continued reference to FIG. 1, the computing device 102 can be communicatively linked to a user interface device (GUI) 126 via a wired and/or wireless link. In various embodiments, the user interface device 126 may include one or more of a display device, for displaying information to users, and a user input device, such as a keyboard or touch or writable screen, for inputting instructions and/or receiving a visual display of the output, and/or a cursor control device, such as a mouse, trackball, or the like, for communicating user input information and command selections to the processor 108. Specifically, the user interface device 126 includes at least one of an input device and an output device, both of which include hardware, and which are communicatively linked with the computing device 102 via wired and/or wireless link(s).

As mentioned, the computing device 102 of the system 100 is communicatively linked with the printer 104 via link 106. While the computing device 102 may be linked to as few as one printer 104, in general, it can be linked to a fleet of printers. The exemplary printers 104 may each include at least one printhead and nozzles situated on the printheads, which propel ink onto media, such as paper, using, for example an inkjet transfer process. By this, the printer 104 may also include an ink well, a wiper, wiper components, and faceplate among other parts.

In the disclosed embodiment, the printer 104 and/or computing device 102 may incorporate or are in communication with one or more sensors 128-132 and/or a timer 134 that supply a measurement in the form of data to the computing device 102. The system 100 may also include a database 136 in communication with the computing device 102 for storing preset variables, thresholds, and historical data that is used by the machine learning component 112 to model the behavior of the printheads.

Moreover, some embodiments may include a non-transitory computer-readable storage medium (e.g., “memory 110”) having computer readable code stored thereon for programming a computer server, appliance, device, processor, circuit, etc., each of which may include a processor to perform functions as described and claimed herein. The memory 110 may represent any type of tangible computer readable medium such as random-access memory (RAM), read only memory (ROM), magnetic disk or tape, optical disk, flash memory, or holographic memory. In one embodiment, the memory 110 may comprise a combination of random-access memory and read only memory. The digital processor 108 can be variously embodied, such as by a single-core processor, a dual-core processor (or more generally by a multiple-core processor), a digital processor and cooperating math coprocessor, a digital controller, or the like. The digital processors 108 in addition to controlling the operation of the computing device 102, executes instructions stored in the components 112-118 for performing the parts of the method outlined below.

The components 112-118 as used herein, are intended to encompass any collection or set of instructions executable by the system 100 to configure the system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on the server or other location to perform certain functions.

The communication interfaces 122, 124 may include, for example, a modem, a router, a cable, and and/or Ethernet port, etc.

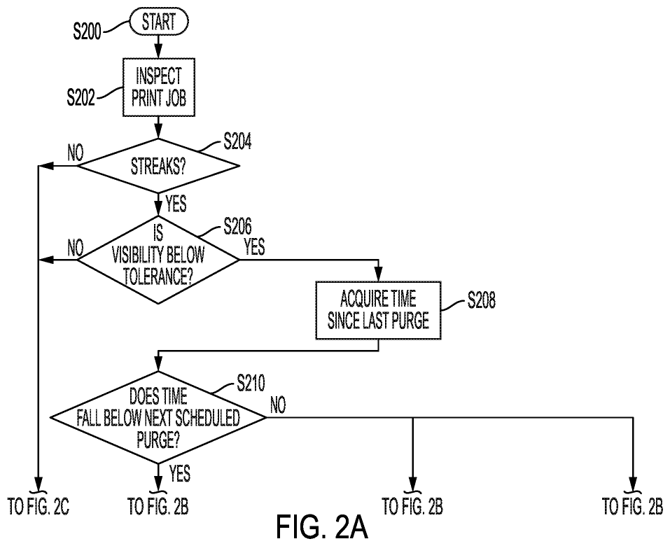

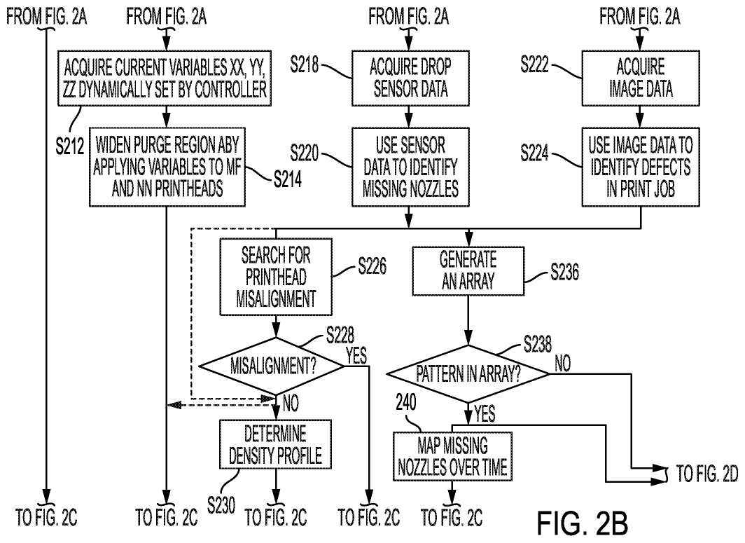

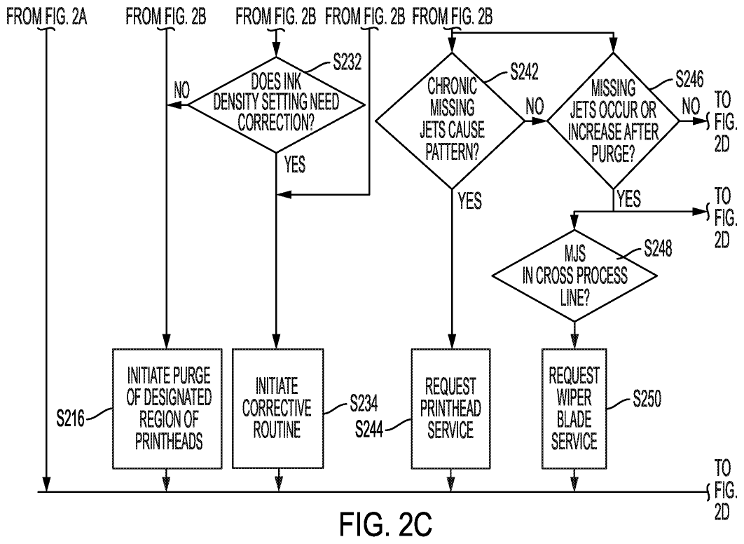

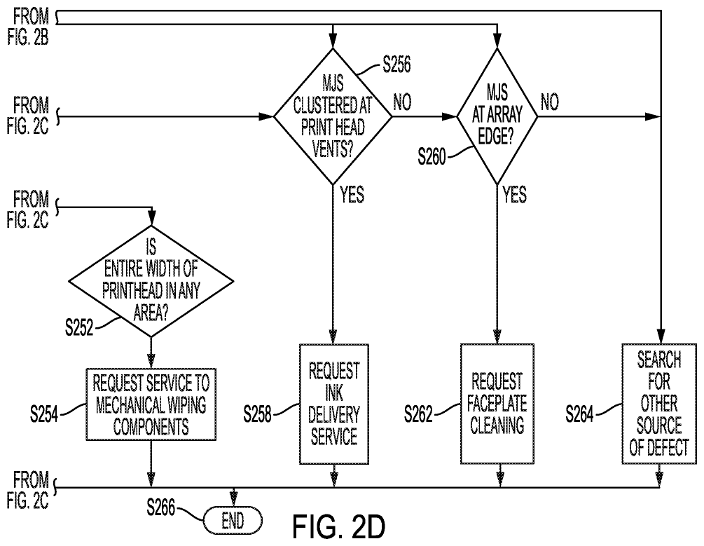

Turning to FIG. 2A, a flowchart of a process for maintaining a printhead is shown according to one aspect of the exemplary embodiment. Machine learning or statistical methods are used to incorporate trends and predictable or recurring changes into the correction strategies. The method starts at S200. The method assumes that a printer is in regular operation and has generated numerous print jobs over the life of the printer. As part of a predetermined, random, or activated diagnostic (“self-test”) routine, the method inspects the printed output that is generated for a select print job at S202. The frequency of self-test for image quality can be preprogrammed, selected by a user, influenced by the AI of the present disclosure, or based on a combination of these or similar influences. The timing of the self-test can be based on historical duty cycle data so that the test is performed during normally idle periods. The printed output can be a test sheet that was generated for the diagnosis. As part of the inspection, the printed output is scanned and analyzed for lines or streaks or other print quality issues within the printed text and/or images (hereinafter “images”).

In another embodiment, the electronic image data of a queued print job is analyzed against current missing nozzles—known by the system—to indicate if a streak will occur. In response to a line or streak or other print quality issue being detected (YES at S204), the system determines if the visibility of the streak is below a predetermined tolerance for image quality. The tolerance or threshold can be preprogrammed and stored in the database 136 and accessed to perform the thresholding. It may depend on the printer properties being selected for the print job or the default settings. These image quality preferences (referred to herein as part of the “10 sensitivity”) may be based on input made by the user using a GUI or by defaults set by the controller, or by a combination of these or similar influences.

In response to the visibility falling below the predetermined tolerance (YES at S206), the system acquires the time that has passed since the last purge cycle at S208. In a different embodiment, the system acquires the time that the printer has been idle at S208. In response to no line or streak being detected (NO at S204) or to the visibility meeting or exceeding the tolerance (NO at S206), the process ends at S266 (FIG. 2D).

If the printer has been idle for more than a predetermined amount of time, then a purge may be desired during the print job or before the next print job starts. To acquire the time at S208 since the last purge cycle or how long the printer has been idle, the system can acquire the time measurement from a timer 134 that it activated after the last purge cycle. The system may store a purge schedule (e.g., every sixty (60) or 120 minutes) or a maximum idleness threshold in the database 136, which sets the purges to specific times or to follow certain events. If the time falls below the idleness threshold (YES at S210), the system acquires the current control variables that are set by the controller at S212 (FIG. 2B). These variables are dynamically set by the controller and stored in the database at 136. The controller continually modifies the variables to maximize printing time and minimize ink usage. Typically, if the current information necessitates a purge, the controller will automatically activate the purge at a time that best balances optimal ink usage with IQ and missing jet rate.

Continuing with FIG. 2B, after acquiring the current variables, the system widens the purge region by applying the variables to the missing nozzles and the designated printheads at S214. Therefore, in an illustrative example, if the nozzles above a predetermined number n_{MJ} (e.g., 100) of missing nozzles or jets (“MJs”) and a predetermined number n_{NN} (e.g., 5) of adjacent missing jets (“NNs”) are preventively purged each time a visible streak occurs, the system may see a reoccurrence before the next scheduled purge. However, in an illustrative example, if the heads above fifty (50) MJs and two (2) NNs are purged, the defect may be remedied and not occur again before the next scheduled purge. Therefore, the purge is initiated at S216 (FIG. 2C) for the designated region of printheads when printing an image with similar image content to the one being printed when this was learned. In one embodiment, the purge is applied to printheads causing the defects and/or to the widened region.

If the time falls below the next purge cycle (that is, the purge has already occurred) (NO at S 210), the system acquires drop sensor data at S218. This data can be acquired from a drop sensor 128 in communication with the printer and which indicates whether ink is being propelled from a nozzle. The drop sensor data is used to identify missing nozzles at S220 by employing known algorithms. Generally, the controller activates the printer to generate an image that employs every nozzle. The image moves past the image sensor (which can be a scanner), which captures an electronic copy of the printed image. The scanned image is processed to detect the pixel locations where ink is absent. These locations are used to identify the nozzles that were assigned to print the pixels, those nozzles are determined to be missing nozzles.

Alternately or in parallel with this process, the system can acquire image data at S222 and use the image data to identify defects in the print job at S224. The image data can be obtained as electronic image data located in a queue and designated for future printing, or it can be obtained by scanning and analyzing a hard copy printout of a print job that has already been generated by the printer. In the former instance, the image data can be acquired from the database 136 or other storage medium. In the latter instance, the image data can be acquired from image sensor 130 and can be used to identify missing nozzles in the printhead by comparison. The image data is used to forecast defects that may result in future print jobs providing what is known about the current operational status of nozzles and defects.

Continuing with FIG. 2B, the machine learning component acquires and analyzes the image and drop data to determine whether the defects align with the missing nozzles or with misdirected nozzles. At S226, the system determines if the printhead is misaligned. Known approaches, such as using printed ruled lines, can be employed for determining if there is misalignment. In response to a determined misalignment (YES at S228), the control component can initiate a corrective routine at S234 (FIG. 2C). For example, a misalignment would necessitate that the position of a printhead is adjusted—not a purge. In one embodiment, the control component can activate the automatic adjustment of the printhead position at the printer 104. In another embodiment, the output module 118 can alternatively or simultaneously transmit an error message or notice to the GUI at the printer 104 or user device 120. In response to a determined misalignment (YES at S228), the control component can determine whether the defect is caused by the ink density at S230 (FIG. 2C).

Alternatively, or in parallel with the misalignment determination, the system can determine an ink density profile at S230. The system can acquire the ink density measurement from a densitometer 132 in communication with the system. In a different embodiment, an image scanner can be employed instead of a densitometer. The densitometer checks the image at one point, while the scanner can measure the profile across the page. The ink density profile is applied to the machine learning component 114 to determine if a correction is desired based on ink usage or a forecasted ink usage. In response to a correction being needed or desired (YES at S234), the control component can initiate a corrective routine at S234. For example, the control component can automatically adjust the settings for ink density. This adjustment can be performed using known algorithms. In another embodiment, the output module 118 can alternatively or simultaneously transmit an error message or notice to the GUI at the printer 104 or user device 120. In response to a correction not being needed or desired (NO at S234), the system can activate a purge at S216 for the predetermined region of printheads. The timing of the purge can be based on historical duty cycle data so that it is performed during normally idle periods. There is a separate duty cycle used for print periods.

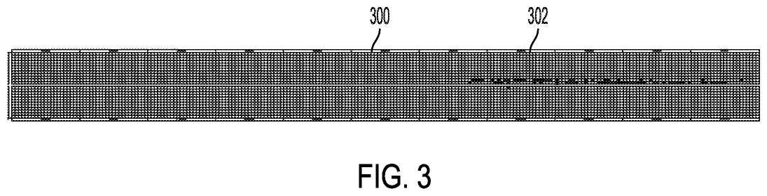

Alternative to or in parallel with the operations of S226-234, the machine learning component can generate an array at S236 using the missing nozzle information. An illustrative example of an array is shown in FIG. 3. The array 300 maps where the missing nozzles 302 appear on the print face of the printhead. FIG. 3 shows an array that is 24 nozzles wide by 231 nozzles long with approximately 75 missing nozzles 302 located along a longitudinal extent of the array.

Returning to FIG. 2B, the machine learning component determines if there is a pattern in the array. The array is used to determine how a defect may appear in a printed output using the current printhead. In other words, the array is used to forecast the quality of the future print job. However, there is no limitation made herein to the analysis being performed using the array. In other contemplated embodiments, the following operations can be performed on the whole array or on sectors (nozzle groups) of the array or on individual nozzles. The method can also be performed for individual nozzles associated with one region of an image and sectors of the array associated with a different region of the faceplate. An additional variation would be to alter, at some appropriate interval, between individual nozzle assessments and sector assessments based on preprogrammed or usage determined schedules. These variations are envisioned as implementation alternatives but may be also selectable or altered in the field based on printer usage and user need.

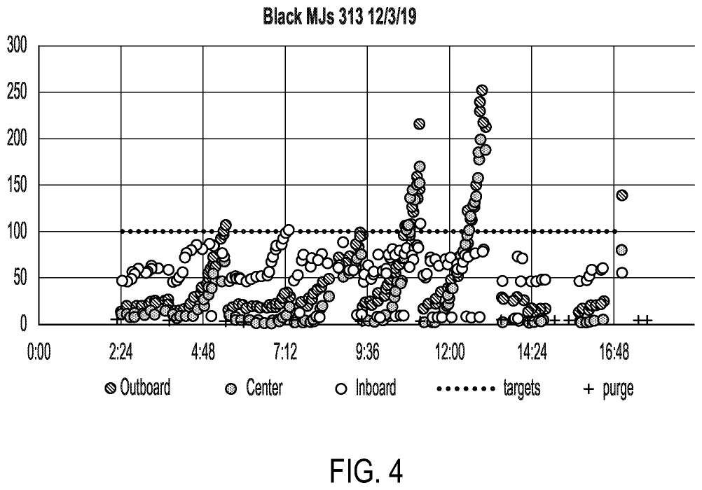

There are several patterns in the array from which a defect can result. The type of pattern can determine the type of defect that may appear in the output. In response to a pattern being detected in the array (YES at S238), the system may, in one embodiment, map the missing nozzles over time at S240. In various embodiments, historical data and mappings are stored in the database 136 and the mapping may only require updating with the new information. In such embodiments, the system can acquire the map of the missing nozzles over time from the database and then update it accordingly. An example mapping of missing nozzle data over time is shown in FIG. 4. The mapping over time is used to determine if the pattern is caused by nozzles that are chronically missing or non-functional. By “chronic”, the disclosure means that the nozzle is nonoperational on a recurring or permanent basis, or it has not been corrected or has only been temporarily corrected after previous purges.

Continuing with FIG. 2C, in response to a chronic missing nozzle causing the pattern in the array (YES at S242), the system initiates a request for printhead service at S244. The output module 118 can transmit an error message or notice to the GUI at the printer 104 or user device 120. In response to the pattern not being caused by chronic missing nozzles (NO at S242), the system can determine if the missing nozzles occur or increase after purge cycles. The mapping of the missing nozzles over time can be analyzed to make this determination. For example, the machine learning component can determine whether missing nozzles, or certain nozzles, occur after a purge and/or whether the number of missing nozzles increase after a purge. In response to the missing nozzles occurring or increasing after a purge (YES at S246), the machine learning component looks to the direction that the missing nozzles are shown on the current array. When a plurality of missing nozzles form a line or appear to be located across the lateral extent of the print face in the array—that is, in a cross-process line with the wiper blade—the defect can be a problem with the wiper blade. Missing nozzles that are physically located in a single line in the direction of the wiper blade travel are typically due to a defect in the wiper blade. These missing nozzles tend to occur immediately after a purge and slowly recover with printing. However, in some cases, the missing jets in a single line can become permanent. By generating the array, the machine learning component can forecast the defects that the current missing nozzles can cause in a print job. Therefore, in response to the missing nozzles being in a cross-process line (YES at S248), the system initiates a request for wiper blade service at S250. The output module 118 can also transmit an error message or notice to the GUI at the printer 104 or user device 120.

In response to the missing nozzles being located across an entire width of a printhead (YES at S252), the system initiates a request for service to the mechanical wiping components at S254. The output module 118 can also transmit an error message or notice to the GUI at the printer 104 or user device 120.

Continuing with FIG. 2D, in response to the missing nozzles being clustered at the printhead vents (YES at S256), the system initiates a request for ink delivery service to at S258. The output module 118 can also transmit an error message or notice to the GUI at the printer 104 or user device 120.

In response to the missing nozzles being located along the longitudinal edge(s) of the array (YES at S260), the system initiates a request for cleaning to the print face at S262. Missing nozzles at the edges of the array can typically result from ink that builds up on the faceplate. In other words, dried ink may be stuck on the wiper blade. The wiper blade may drag the dry ink across the print face of the printhead and cause defects in the print job. Therefore, the output module 118 can transmit the request, an error message or notice to the GUI at the printer 104 or user device 120.

Steps S240, S246, S256, and S260 can be performed in the sequence disclosed herein, for illustrative purposes only, or in alternate sequences that include or omit certain ones of the steps. Also, the corrective actions that follow the service calls of S234, S244, S250, S254, S258, and S262 can be performed on the same or independent times as part of a preprogrammed schedule selected by the user, a dynamic schedule based on idle periods of the printer, or both. In certain embodiments, the time and type of notice or service message can be based on the criticality of the issue. Non-critical issues can be added to the queue of upcoming preventive maintenance in lieu of a notice.

Based on the continued learning of the different printhead behaviors, the machine learning component 14 can forecast defects in the printed output for certain printer or printhead conditions that may be present or approaching. Over time, the machine learning component 14 is operable to identify common patterns and then use this knowledge to learn what causes different ones of the patterns. The component 14 can also use this intelligence to search for and detect a certain pattern using the current conditions. Based on the type of forecast, the component 14 may suggest appropriate alerts and remedies from successful solutions that were employed for previous incidents.

The disclosure further contemplates embodiments where the IQ sensitivity can be selected from multiple quality modes. In a high-quality mode, the controller activates corrective action when any image defect is present; in a medium-quality mode, the controller activates corrective action when the missing jets cause a noticeable defect; and in a low-quality mode, the controller activates action only when image or text information is lost by the defect; in a failure mode, the controller activates corrective action only when a nozzle failure may become permanently; or a combination of the above.

In response to the determinations being in the negative (NO at S238, S242, S246, S256, or S260), the system can search for another source of the defects or forecasted defects at S264. For example, the system may determine if the missing nozzles are falsely designated as nonfunctional (as a consequence of, for example, misregistered diagnostic images, a poorly focused image sensor; or a preprinted diagnostic image form); whether the missing nozzles align with non-uniformities in the platen motion control data; whether the missing nozzles occur with certain media or modes (e.g., duplex mode); whether particular image patterns are likely to cause missing nozzles on certain media; and whether image content patterns affect missing nozzle accumulation; etc. The method ends at S266.

Therefore, by employing settings and data from the image-based controls and knowledge of the user's desired IQ sensitivity, the machine learning component is operable to track missing nozzles at the pixel level and to predict when the printhead, wiper blade, or other mechanical components require correction for ensuring or improving the quality of a print jobs. The disclosure contemplates that select correction actions are not needed for every print job while they may be required for certain types of print jobs. By tracking a history of purge cycles—more particularly the nozzle behavior after previous purge cycles—and other corrective services or actions, the machine learning component learns the various causes of missing nozzles and which actions are needed to prevent or remedy different manifestations of them.

This combined knowledge will yield a more intelligent use of automatic routines and provides a system with an ability to recommend service actions at the appropriate times. By determining and/or learning nozzles' operational status at the pixel level, and by applying that information to electronic image data—that is, the pixels in queued print jobs—and to the predetermined settings (tolerance) for visual imperfections in the printed output, the machine learning component can determine when and how a printer needs to be serviced. If the learned data indicates that a purge cycle is appropriate, the system will automatically activate the purge to be performed at a time that best balances the optimal ink usage with the ink drying properties and other settings.

The system also tracks missing nozzle data over time to identify trends in missing nozzle counts. The system tracks the locations of missing nozzles on the printhead faceplate and a frequency of actions known to reduce or eliminate the causes which would affect the nozzles' functionality. This enables the system to predict when and/or what solutions may be more effective than a purge. In cases when missing nozzles cannot be recovered by a purge or their non-functionality reoccurs over time, the system activates diagnostic routines or transmits service requests to bring the system back to expected performance.

One aspect of the present disclosure is a system that proactively and automatically maintains printheads based on customizable and dynamic usage information. A weak or missing nozzle results in the absence of an acceptable ink pixel in the image at the locations addressed by that particular nozzle. Some nozzles may never be called upon in a typical print job. By applying the disclosed method, the system may avoid unnecessary corrective actions when a functioning nozzle is not required in a certain location.

Additionally, poor performing nozzles may self-clear and return to functionality after normal use. One aspect of the present disclosure is a system that identifies trends based on the dynamic printer usage and print job histories, and uses the trends to forecast the quality of queued or future print jobs. The system is then able to use the forecast or prediction to activate an appropriate response.

Another aspect of the present disclosure is a system that proactively and automatically compensates based on the performance of printheads. The location and number of nozzle substitutions statistically called upon for actual imaging may appreciably slow printer throughput. The present disclosure employs a correction threshold that would only be exceeded if the operational statuses of the nozzles and the statistical nozzle usage indicate that a targeted performance level is not or will not be met. This system ensures that longer down time and higher repair costs are not incurred unless necessary.

One other aspect of the present disclosure is a system that not only improves the success rate of purge cycles, it will also reduce the amount of ink and service time required for correcting missing nozzles.

Another aspect of the disclosure is a more intelligent use of automatic routines (e.g., diagnostic routines). Additionally, the disclosed system improves on existing systems by recommending service actions at appropriate times.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A system operative on a printhead, comprising:
a processor that executes the following computer executable components stored in a memory, comprising:
a first component to receive data generated by at least one sensor;
a second component to generate an array that determines between activating one of a purge routine and a diagnostic routine on the printhead based on the array, the array being a function of the data; and
a control component operable to selectively activate the purge routine on the printhead based on the determination.

2. The system of claim 1, wherein the second component is a machine learning component that employs a machine learning and artificial intelligence (AI) to forecast potential defects in images to be rendered by the printhead.

3. The system of claim 2, wherein, using the array, the machine learning component is operable to determine a cause for defect in the printhead and determine between the activating the one of the purge and diagnostic routines based on the cause of defect.

4. The system of claim 2, wherein the machine learning component is operable to:
track nozzles on a pixel-by-pixel basis;
detect a pattern across the missing nozzles; and
activate the one of the purge and diagnostic routines based on the detected pattern.

5. The system of claim 2, wherein the machine learning component is operative to weigh the forecasted defect against a predetermined tolerance; and
wherein the control component is operative to activate one of the purge and a diagnostic routine in response to the tolerance not being met.

6. The system of claim 5, wherein the tolerance relates to a visibility of a streak on an image rendered by the system.

7. The system of claim 1, wherein the second component is a machine learning component that is capable of leveraging the data collected by the at least one sensor and images to activate at least one of the purge and diagnostic routines;
wherein the images belong to at least one of a history of images having been rendered by the system and a queue of images to be rendered by the system.

8. The system of claim 1, wherein the second component is operable to use the array to forecast consumption of a consumable material used by the system.

9. The system of claim 8, wherein the consumable material is ink.

10. The system of claim 1 further comprising the at least one sensor, the at least one sensor being operative to detect input selected from the group consisting:
missing nozzles on a printhead having numerous nozzles;
image quality caused by the missing nozzles; and
a combination of the above.

11. The system of claim 1, wherein the array maps the missing nozzles relative to a physical location of the nozzles on the printhead.

12. The system of claim 1, wherein following the diagnostic routine, the control component is operable to activate an automated corrective routine or transmit a notice of defect to user device.

13. The system of claim 1, wherein the diagnostic routine for performing a diagnostic function selected from the group consisting:
aligning printheads with one another;
aligning a printhead array with media;
generating a list of defects that need servicing; and
a combination of the above.

14. A system operative on a printhead, comprising:
an ink-jet recording device including the printhead that ejects ink droplets from a plurality of nozzles;
a first sensor to detect data relating to the nozzles on the printhead; and
a processor to execute computer executable components stored in a memory, comprising:
a machine learning component to employ artificial intelligence (AI) to learn the data generated by the sensor for determining between selectively activating one of a purge routine and not activating the purge routine.

15. The system of claim 14, wherein the data identifies nonoperational nozzles on the printhead.

16. The system of claim 15, wherein the machine learning component employs the data to map an array of the non-operational nozzles relative to the printhead.

17. The system of claim 16, wherein the machine learning component uses the array to forecast a defect in a future print job.

18. The system of claim 17, wherein the processor is further operative to:
weigh the forecasted defect against a predetermined tolerance threshold; and
activate one of the purge and a diagnostic routine in response to the tolerance not being met.

19. The system of claim 14 further comprising a second sensor to measure defects in an image rendered or to be rendered by the system.

20. A system for use with an associated printhead, comprising:
a non-transitory storage device having stored thereon instructions for:
acquiring data from a drop sensor monitoring nozzles on the associated printhead; and
using the data, generating a map representing the nozzles on the associated printhead;
employing artificial intelligence to forecast a potential defect in images to be rendered by the printhead; and
selectively initiating a maintenance to be performed on an associated printhead based on the forecasted defect, the associated printhead being in communication with at least one hardware processor configured to execute the instructions.
